(19) United States
(12) Patent Application Publication
(10) Pub. No.: US 2025/0306498 A1
(43) Pub. Date: Oct. 2, 2025

(54) CHARGING DEVICE, IMAGE FORMING UNIT, AND IMAGE FORMING APPARATUS

(71) Applicant: FUJIFILM Business Innovation Corp., Tokyo (JP)

(72) Inventors: Yuki NAGAMORI, Kanagawa (JP); Tsutomu SUGIMOTO, Kanagawa (JP); Go MIURA, Kanagawa (JP)

(73) Assignee: FUJIFILM Business Innovation Corp., Tokyo (JP)

(21) Appl. No.: 18/820,283

(22) Filed: Aug. 30, 2024

(30) Foreign Application Priority Data
Mar. 27, 2024 (JP) 2024-052053

(51) Int. Cl. G03G 15/02

(52) U.S. Cl. CPC G03G 15/0291; G03G 2215/027

(57) ABSTRACT

A charging device includes a discharge electrode; and a control electrode that is disposed between the discharge electrode and a charged body that is charged by the discharge electrode, in which the control electrode includes plural linear conductors disposed to intersect a rotation direction of the charged body at any angle, and plural connection portions that are members of connecting the linear conductors along the rotation direction of the charged body, and are disposed more in a region of a central portion than in a region of both end portions in a direction intersecting the rotation direction of the charged body.

### CROSS-REFERENCE TO RELATED APPLICATIONS

This application is based on and claims priority under 35 USC 119 from Japanese Patent Application No. 2024-052053 filed Mar. 27, 2024.

### BACKGROUND

### (i) Technical Field

The present invention relates to a charging device, an image forming unit, and an image forming apparatus.

### (ii) Related Art

In the related art, as techniques related to charging devices, for example, charging devices disclosed in JP2013-045060A, JP2012-203364A, and the like have already been proposed.

In JP2013-045060A, a grid electrode has a plurality of regions in which the opening pitches in a rotation axis direction are different from each other, and a region facing a discharge electrode among the plurality of regions is configured to have a smaller opening pitch than a non-facing region.

In JP2012-203364A, a potential control board includes three or more structural lines arranged in a circumferential direction of a charged body and linearly extending along an axial direction of the charged body, and a plurality of connection portions disposed in the axial direction of the charged body and connecting a part of the three or more structural lines to be continuous in the circumferential direction of the charged body, and the structural lines connecting one of the plurality of connection portions to another connection portion are at least partially different from each other.

### SUMMARY

Aspects of non-limiting embodiments of the present disclosure relate to a charging device, an image forming unit, and an image forming apparatus that suppress occurrence of a charging unevenness due to vibration of a control electrode as compared with a case where a plurality of connection portions constituting the control electrode are uniformly disposed along an axial direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a charging device that includes a discharge electrode; and a control electrode that is disposed between the discharge electrode and a charged body that is charged by the discharge electrode, in which the control electrode includes a plurality of linear conductors disposed to intersect a rotation direction of the charged body at any angle, and a plurality of connection portions that are members of connecting the linear conductors along the rotation direction of the charged body, and are disposed more in a region of a central portion than in a region of both end portions in a direction intersecting the rotation direction of the charged body.

### BRIEF DESCRIPTION OF THE DRAWINGS

Exemplary embodiment(s) of the present invention will be described in detail based on the following figures, wherein:

FIG. 1 is an overall configuration diagram illustrating an image forming apparatus to which a charging device according to a first exemplary embodiment of the present invention is applied;

FIG. 2 is a configuration diagram illustrating an image creating device of the image forming apparatus according to the first exemplary embodiment of the present invention;

FIG. 3 is a perspective configuration diagram illustrating an image forming unit according to the first exemplary embodiment of the present invention;

FIG. 4 is a perspective configuration diagram illustrating a unit body of the image forming unit according to the first exemplary embodiment of the present invention;

FIG. 5 is a perspective configuration diagram illustrating a grid electrode of a charging device according to the first exemplary embodiment of the present invention;

FIGS. 6A and 6B are configuration diagrams illustrating a controller of the grid electrode;

FIG. 7 is a configuration diagram illustrating a principle of a charging device;

FIG. 8 is a perspective configuration diagram illustrating a grid electrode of a charging device according to the first exemplary embodiment of the present invention;

FIG. 9 is a perspective configuration diagram illustrating a charging device according to the first exemplary embodiment of the present invention;

FIG. 10 is a perspective configuration diagram illustrating an insulating block of a rear end of the charging device according to the first exemplary embodiment of the present invention;

FIG. 11 is a perspective configuration diagram illustrating an insulating block of a front end of the charging device according to the first exemplary embodiment of the present invention;

FIGS. 12A and 12B are configuration diagrams illustrating a tension member;

FIG. 13 is a sectional configuration diagram illustrating main parts of the insulating block of the front end;

FIG. 14 is a planar configuration diagram illustrating the grid electrode of the charging device according to the first exemplary embodiment of the present invention;

FIG. 15 is a schematic diagram illustrating a facing region in the charging device according to the first exemplary embodiment of the present invention;

FIG. 16 is a planar configuration diagram illustrating a grid electrode of a charging device according to a second exemplary embodiment of the present invention;

FIG. 17 is a planar configuration diagram illustrating a grid electrode of a charging device according to a third exemplary embodiment of the present invention; and

FIG. 18 is a planar configuration diagram illustrating a grid electrode of a charging device according to a fourth exemplary embodiment of the present invention.

### DETAILED DESCRIPTION

Hereinafter, exemplary embodiments of the present invention will be described with reference to the drawings.

### First Exemplary Embodiment

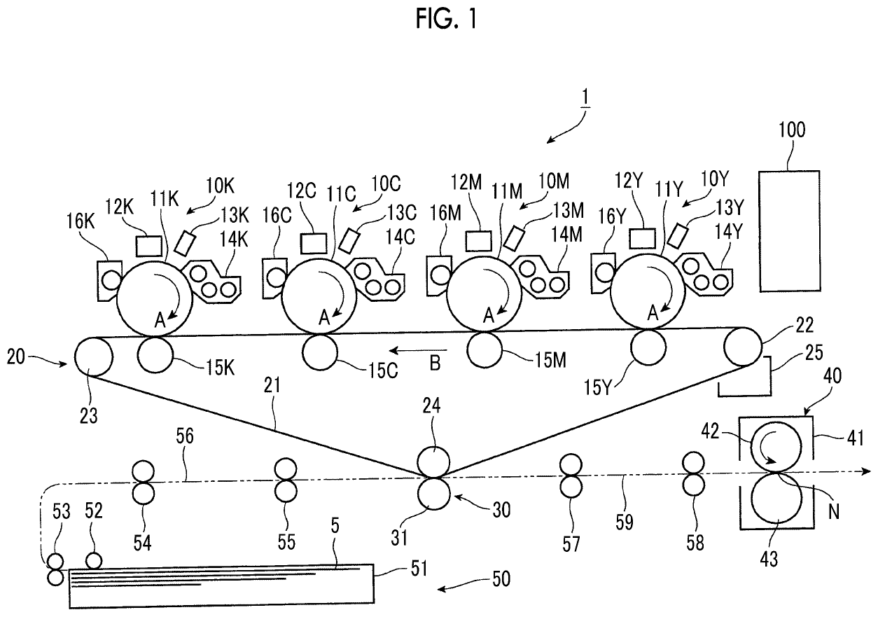

FIG. 1 is a configuration diagram illustrating the overall outline of an image forming apparatus to which a charging device and an image forming unit according to a first exemplary embodiment of the present invention are applied.

### Overall Configuration of Image Forming Apparatus

An image forming apparatus 1 according to the first exemplary embodiment is configured as, for example, a color printer. As illustrated in FIG. 1, the image forming apparatus 1 includes a plurality of image creating devices 10, an intermediate transfer device 20, a paper feeding device 50, a fixing device 40, and the like. The plurality of image creating devices 10 form toner images which are developed by toner constituting a developer. The intermediate transfer device 20 holds the toner image formed by each image creating device 10, and transports the toner image to a secondary transfer position where the toner image is secondarily transferred to a recording sheet 5, which is an example of a recording medium, in the end. The paper feeding device 50 accommodates and transports the required recording sheet 5 to be supplied to the secondary transfer position of the intermediate transfer device 20. The fixing device 40 fixes the toner image on the recording sheet 5 to which the toner image has been secondarily transferred by the intermediate transfer device 20. Note that a two-dot chain line in the drawing indicates a main transport path along which the recording sheet 5 is transported inside the image forming apparatus 1.

The image creating device 10 includes four image creating devices 10Y, 10M, 10C, and 10K that exclusively form toner images of four colors including yellow (Y), magenta (M), cyan (C), and black (K), respectively. The four image creating devices 10 (Y, M, C, K) are disposed in a row along the horizontal direction in an inner space of the image forming apparatus 1.

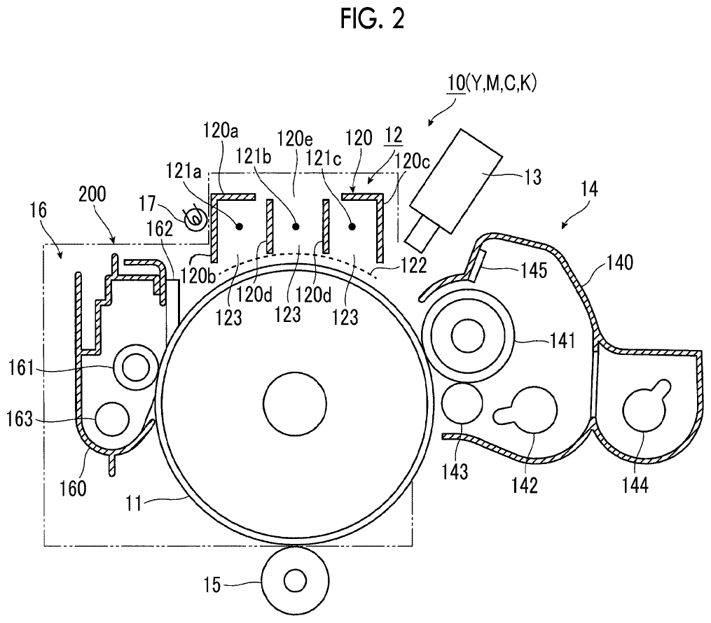

As illustrated in FIG. 2, each image creating device 10 (Y, M, C, K) includes a rotating photosensitive drum 11 as an example of a charged body and an image holding unit. Around the photosensitive drum 11, there are a charging device 12 as an example of a charging unit according to the first exemplary embodiment, an exposure device 13 as an example of an electrostatic latent image forming unit, a developing device 14, a primary transfer device 15, a drum cleaning device 16, and the like. The charging device 12 charges a peripheral surface (an image holding surface) of the photosensitive drum 11, on which an image can be formed, to a required potential. The exposure device 13 irradiates the charged peripheral surface of the photosensitive drum 11 with light based on image information (a signal) to form an electrostatic latent image with a potential difference (for each color). The developing device 14 develops the electrostatic latent image with toner of the developer of the corresponding color (Y, M, C, K) to obtain a toner image. The primary transfer device 15 transfers each toner image to the intermediate transfer device 20.

The drum cleaning device 16 removes and cleans adhesive substances, such as toner, remaining on and adhering to the image holding surface of the photosensitive drum 11 after the primary transfer.

The photosensitive drum 11 is obtained by forming, on a peripheral surface of a cylindrical or columnar base material to be grounded, an image holding surface including a photoconductive layer (a photosensitive layer) consisting of a photosensitive material. The photosensitive drum 11 is supported to rotate in a direction indicated by arrow A, as an example of a movement direction, by receiving a driving force transmitted from a drive unit (not illustrated). As illustrated in FIG. 2, the surface shape of the photosensitive drum 11 is curved in a circular shape having a required curvature radius about a rotation axis.

The charging device 12 is configured by a so-called scorotoron charger that is disposed in a state of being separated from the photosensitive drum 11. The scorotoron charging device 12 has a higher charging ability for the photosensitive drum 11 as compared with a charging roll having a roll shape. Therefore, the scorotoron charging device 12 is particularly effective in the high-productivity image forming apparatus 1, in which a rotation speed of the photosensitive drum 11, which determines a process speed, is increased. A charging voltage and a control voltage are supplied to the charging device 12. As the charging voltage, in a case where the developing device 14 performs reverse development, a voltage or current having the same polarity as the charging polarity of the toner supplied from the developing device 14 is supplied. Note that the configuration of the charging device 12 will be described in detail later.

The exposure device 13 consists of an LED printhead. The LED printhead irradiates the photosensitive drum 11 with light according to the image information by light emitting diodes (LEDs) serving as a plurality of light emitting elements arranged along an axial direction of the photosensitive drum 11 to form an electrostatic latent image. Note that, as the exposure device 13, a device that performs deflection and scanning along the axial direction of the photosensitive drum 11 with laser light configured according to the image information may be used.

As illustrated in FIG. 2, any developing device 14 is configured by disposing a developing roll 141, an agitation supply member 142, a developer supply roll 143, an agitation transport member 144, a layer thickness regulation member 145, and the like in a housing 140. Inside the housing 140, an opening portion at a position facing the photosensitive drum 11 and an accommodation chamber for a developer are formed. The developing roll 141 holds a developer, and transports the developer to a development region that faces the photosensitive drum 11. The agitation supply member 142 consists of a screw auger or the like that supplies the developer such that the developer passes through the developing roll 141 while agitating the developer. The developer supply roll 143 supplies the developer supplied from the agitation supply member 142 to the developing roll 141. The agitation transport member 144 consists of a screw auger or the like that transports the developer to the agitation supply member 142 while agitating the developer. The layer thickness regulation member 145 regulates the amount (layer thickness) of the developer held on the developing roll 141. In the developing device 14, a developing voltage is supplied from a power supply device (not illustrated) to a portion between the developing roll 141 and the photosensitive drum 11. For example, a two-component developer containing a non-magnetic toner and a magnetic carrier is used as the developers of four colors.

The primary transfer device 15 is a contact-type transfer device including a primary transfer roll that rotates around the photosensitive drum 11 in contact with the photosensitive drum 11 via an intermediate transfer belt 21 and that is supplied with a primary transfer voltage. As the primary transfer voltage, a direct-current voltage having a polarity opposite to the charging polarity of the toner is supplied from the power supply device (not illustrated).

The drum cleaning device 16 is configured by a body 160, a cleaning brush 161, a cleaning plate 162, a sending member 163, and the like. The body 160 is formed in a container shape of which a portion is open. The cleaning brush 161 is disposed to be in contact with the peripheral surface of the photosensitive drum 11 after the primary transfer with a required pressure, and performs cleaning by scraping off the adhesive substances such as residual toner. The cleaning plate 162 is disposed to be in contact with the peripheral surface of the photosensitive drum 11 with a required pressure, and performs cleaning by removing the adhesive substances such as residual toner. The sending member 163 consists of a screw auger or the like that transports the adhesive substances such that the adhesive substances such as the toner removed by the cleaning brush 161 and the cleaning plate 162 are collected and the adhesive substances are sent to a collection system (not illustrated). As the cleaning plate 162, a plate-shaped member (for example, a blade) consisting of a material such as rubber is used.

A charge erasing lamp 17 is disposed between the drum cleaning device 16 and the charging device 12. The charge erasing lamp 17 erases the charge by uniformly exposing the surface of the photosensitive drum 11 from which the adhesive substances such as residual toner have been removed by the drum cleaning device 16.

As illustrated in FIG. 1, the intermediate transfer device 20 is disposed to be at a position below each image creating device 10 along a vertical direction. The intermediate transfer device 20 is mainly configured by an intermediate transfer belt 21, a plurality of belt support rolls 22 to 24, a secondary transfer device 30, and a belt cleaning device 25. The intermediate transfer belt 21 rotates in a direction indicated by arrow B while passing through a primary transfer position between the photosensitive drum 11 and the primary transfer device 15 (primary transfer roll). The plurality of belt support rolls 22 to 24 rotatably support the intermediate transfer belt 21 by holding the intermediate transfer belt 21 from the inner surface thereof in a desired state. The secondary transfer device 30 is disposed on an outer peripheral surface (image holding surface) side of the intermediate transfer belt 21 supported by the belt support roll 24, and secondarily transfers a toner image on the intermediate transfer belt 21 to the recording sheet 5. The belt cleaning device 25 performs cleaning by removing the adhesive substances such as toner and paper dust, which remain and adhere to the outer peripheral surface of the intermediate transfer belt 21 after passing through the secondary transfer device 30.

For example, an endless belt made of a material, in which a resistance adjusting agent such as carbon black is dispersed in a synthetic resin such as a polyimide resin and a polyamide resin, is used as the intermediate transfer belt 21. In addition, the belt support roll 22 is configured as a drive roll that is rotationally driven by a drive device (not illustrated). The belt support roll 23 is configured as a surface leveling roll that holds an image forming surface of the intermediate transfer belt 21. The belt support roll 24 is configured as a facing roll that faces the secondary transfer device 30. The belt support roll 22 also functions as a support roll that supports a back surface of the belt cleaning device 25.

As illustrated in FIG. 1, the secondary transfer device 30 is a contact-type transfer device including a secondary transfer roll 31. The secondary transfer roll 31 rotates in contact with the peripheral surface of the intermediate transfer belt 21 and is supplied with a secondary transfer voltage, at the secondary transfer position that is an outer peripheral surface portion of the intermediate transfer belt 21, which is supported by the belt support roll 24, in the intermediate transfer device 20. In addition, as the secondary transfer voltage, a direct-current voltage having the opposite polarity or the same polarity as the charging polarity of the toner is supplied from the power supply device (not illustrated) to the secondary transfer roll 31 or the belt support roll 24 of the intermediate transfer device 20.

The fixing device 40 is configured by disposing a heating rotor 42, a pressurizing rotor 43, and the like in a housing 41. An introduction port and a discharge port for the recording sheet 5 are formed in the housing 41. The heating rotor 42 is formed in a belt form or a roll form that rotates in a direction indicated by an arrow and is heated by a heating unit such that the surface temperature is maintained at a predetermined temperature. The pressurizing rotor 43 is formed in a roll form or a belt form that is in contact with the heating rotor 42 at a predetermined pressure in a state of being substantially along the axial direction of the heating rotor 42 and that is driven to rotate. In the fixing device 40, a contact portion where the heating rotor 42 and the pressurizing rotor 43 are in contact with each other is a fixing nip portion N where required fixing processing (heating and pressurization) is performed.

The paper feeding device 50 is disposed to be present at a position below the intermediate transfer device 20. The paper feeding device 50 is mainly configured by a single (or a plurality of) sheet accommodation body 51 and sending devices 52 and 53. The sheet accommodation body 51 accommodates the recording sheet 5 having a desired size, type, and the like in a loaded state. The sending devices 52 and 53 send the recording sheet 5 one by one from the sheet accommodation body 51. The sheet accommodation body 51 is provided, for example, to be able to be pulled out to the front surface (side surface that the user faces at the time of operating the apparatus) of the apparatus body (not illustrated).

Examples of the recording sheet 5 include thin paper such as plain paper and tracing paper, OHP sheets, and the like, which are used in electrophotographic copying machines and printers. In order to further improve the smoothness of an image surface after fixing, for example, it is preferable that the surface of the recording sheet 5 is as smooth as possible. For example, as the recording sheet 5, coated paper in which the surface of plain paper is coated with resin or the like, so-called thick paper such as art paper for printing, or the like having a relatively large basis weight can also be suitably used.

A plurality of or single sheet transport roll pairs 54 and 55 and a paper feed transport path 56 are provided between the paper feeding device 50 and the secondary transfer device 30. The sheet transport roll pairs 54 and 55 transport the recording sheet 5 sent from the paper feeding device 50 to the secondary transfer position. The paper feed transport path 56 is configured by a transport guide (not illustrated). The sheet transport roll pair 55 disposed at a position immediately before the secondary transfer position in the paper feed transport path 56 is configured as, for example, a roll (registration roll) that adjusts the transport timing of the recording sheet 5. In addition, a plurality of or single sheet transport roll pairs 57 and 58 and a sheet transport path 59, which are for transporting the recording sheet 5 after the secondary transfer sent from the secondary transfer device 30 to the fixing device 40, are provided between the secondary transfer device 30 and the fixing device 40. Note that a sheet discharge unit (not illustrated) that discharges the recording sheet 5 after fixing, which is sent from the fixing device 40, is provided on a side surface of the image forming apparatus 1.

Note that the image forming apparatus 1 may include a duplex sheet transport path (not illustrated) for forming an image on both sides of the recording sheet 5.

Reference sign 100 in FIG. 1 indicates a control device that comprehensively controls the operation of the image forming apparatus 1. The control device 100 includes a central processing unit (CPU), a read only memory (ROM), a random access memory (RAM), a bus that connects the CPU, the ROM, and the like to each other, a communication interface, and the like (not illustrated).

### Configuration of Image Forming Unit

As illustrated in FIG. 2, the image forming apparatus 1 according to the first exemplary embodiment includes a plurality of image forming units 200 corresponding to the respective image creating devices 10 (Y, M, C, K) in order to improve maintainability. Each image forming unit 200 is configured by integrating a plurality of members, including at least the photosensitive drum 11, into a unit, among the members constituting the respective image creating devices 10. The respective image forming units 200 are individually attachable to and detachable from the image forming apparatus 1.

In the first exemplary embodiment, as illustrated in FIG. 2, the photosensitive drum 11, the charging device 12, and the drum cleaning device 16 are integrally configured as the image forming unit 200. Note that the charging device 12 may be configured to be attachable to and detachable from the photosensitive drum 11 and the drum cleaning device 16 independently. The image forming unit 200 is replaced with a new one in a case where a member such as the photosensitive drum 11 reaches the end of the life of the member. In addition, the image forming unit 200 is replaced with a new one in a case where a failure occurs in the charging device 12 or the drum cleaning device 16. In a case where the image forming unit 200 does not include the developing device 14, the common image forming unit 200 can be used corresponding to all the image creating devices 10.

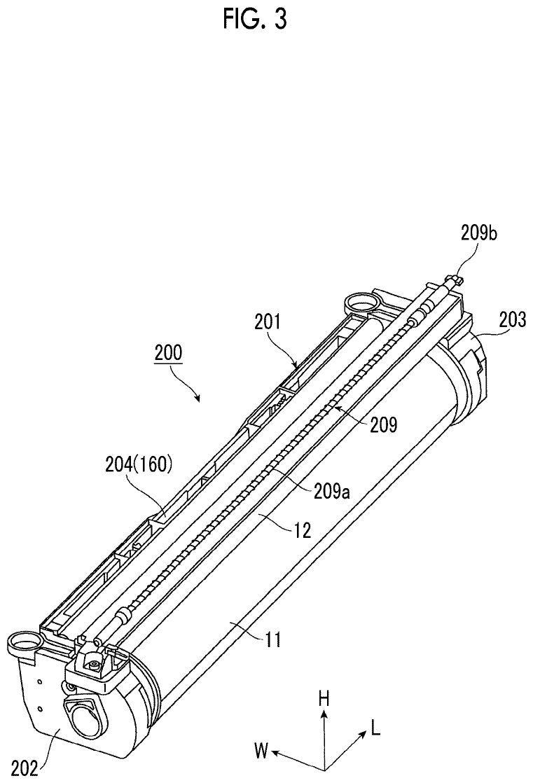

As illustrated in FIG. 3, the image forming unit 200 includes a unit body 201. The unit body 201 includes front and rear support portions 202 and 203, and a connection portion 204.

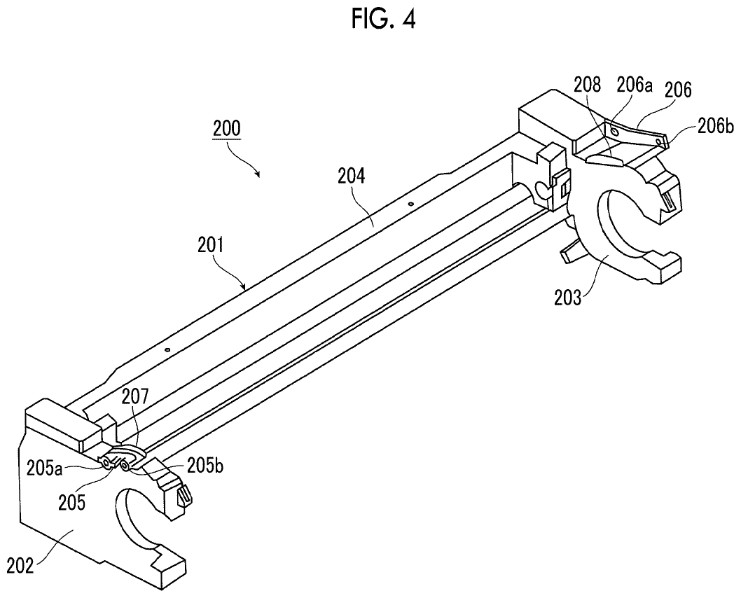

The front and rear support portions 202 and 203 rotatably support both end portions along the axial direction of the photosensitive drum 11. The connection portion 204 connects the front and rear support portions 202 and 203 on one side surface of the photosensitive drum 11. As illustrated in FIG. 4, the front and rear support portions 202 and 203 are provided with front and rear positioning portions 205 and 206 that position both end portions along a longitudinal direction of the charging device 12. In the front and rear positioning portions 205 and 206, positioning holes 205a and 205b and positioning holes 206a and 206b for positioning the charging device 12 are respectively open.

In the front and rear support portions 202 and 203 of the unit body 201, curved portions 207 and 208 are provided. The curved portions 207 and 208 support a grid electrode 122 of the charging device 12 in a curved shape conforming to the surface shape of the photosensitive drum 11 in a case where the charging device 12 is mounted. The curved portions 207 and 208 are formed in an arc shape that protrudes by a required distance with respect to the surface of the photosensitive drum 11 mounted to be rotatable in the image forming unit 200. The height of the curved portions 207 and 208 determines a gap (DGS) between the surface of the photosensitive drum 11 and the grid electrode 122 of the charging device 12.

In addition, the connection portion 204 of the unit body 201 also serves as the body 160 of the drum cleaning device 16 as illustrated in FIG. 3. Note that a drive shaft 209 having helical convex portions 209a on the outer periphery thereof is rotatably attached to an upper portion of the charging device 12. The drive shaft 209 drives a cleaning device (not illustrated) that cleans the charging device 12, along the axial direction of the photosensitive drum 11. An adapter portion 209b to which a driving force is transmitted from the image forming apparatus 1 in a case where the image forming unit 200 is mounted on the image forming apparatus 1 is provided at an end portion on the inner side along the axial direction of the drive shaft 209.

The image forming unit 200 is configured to be insertable and drawable along a depth direction intersecting a width direction of the image forming apparatus 1 from an opening portion provided on a front surface of an apparatus body (not illustrated) of the image forming apparatus 1. In this case, the image forming apparatus 1 is in a state where a front cover (not illustrated) is opened.

### Operation of Image Forming Apparatus

Hereinafter, a basic image forming operation by the image forming apparatus 1 will be described.

Here, the operation in a full-color mode in which a full-color image configured by combining toner images of four colors (Y, M, C, K) is formed using the four image creating devices 10 will be described.

The image forming apparatus 1 receives image information and request command information for a full-color image forming operation (print) from a personal computer, an image reading device, or the like (not illustrated). Then, the control device 100 starts the four image creating devices 10, the intermediate transfer device 20, the secondary transfer device 30, the fixing device 40, and the like.

Then, as illustrated in FIG. 1, in each of the image creating devices 10, first, the photosensitive drum 11 is rotated in a direction along the arrow A. Each charging device 12 charges the surface of the photosensitive drum 11 to a required polarity (negative polarity in the first exemplary embodiment) and a required potential. Subsequently, the exposure device 13 irradiates the surface of the photosensitive drum 11 after charging with light emitted on the basis of the signal of the image obtained by the conversion into each color component (Y, M, C, K). As a result, the electrostatic latent image of each color component having a required potential difference is formed on the surface of the photosensitive drum 11.

Next, each developing device 14 develops the electrostatic latent image of each color component formed on the photosensitive drum 11 by supplying toner of the corresponding color (Y, M, C, K) charged to the required polarity (negative polarity) from the developing roll 141 and causing the toner to electrostatically adhere to the electrostatic latent image. Through such development, the electrostatic latent image of each color component formed on each photosensitive drum 11 is visualized as the toner image of four colors (Y, M, C, K) developed with the toner of the corresponding color.

Next, the toner images of the respective colors which are formed on the photosensitive drum 11 of the image creating devices 10 are transported to the primary transfer positions. Then, the primary transfer devices 15 primarily transfer the toner images of the respective colors onto the intermediate transfer belt 21 of the intermediate transfer device 20 to be superimposed sequentially, the intermediate transfer belt 21 rotating in a direction along the arrow B.

In addition, in each image creating device 10 in which the primary transfer is ended, the drum cleaning device 16 cleans the surface of the photosensitive drum 11 by removing the adhesive substances such that the adhesive substances are scraped off. Thereafter, the charge erasing lamp 17 eliminates the static charge by uniformly exposing the surface of the photosensitive drum 11. Accordingly, each image creating device 10 is brought into a state where the next image creation operation can be performed.

Next, in the intermediate transfer device 20, the toner images that are primarily transferred are held and transported to the secondary transfer position by the rotation of the intermediate transfer belt 21. On the other hand, in the paper feeding device 50, the required recording sheet 5 is sent to the paper feed transport path 56 in accordance with the image creation operation. In the paper feed transport path 56, the sheet transport roll pair 55 as the registration roll sends out and supplies the recording sheet 5 to the secondary transfer position in accordance with the transfer timing.

At the secondary transfer position, the secondary transfer device 30 collectively secondarily transfers the toner images on the intermediate transfer belt 21 to the recording sheet 5. In addition, in the intermediate transfer device 20 in which the secondary transfer is ended, the belt cleaning device 25 performs cleaning by removing the adhesive substances such as toner remaining on the surface of the intermediate transfer belt 21 after the secondary transfer.

Subsequently, the recording sheet 5 on which the toner image is secondarily transferred is peeled off from the intermediate transfer belt 21 and then is transported to the fixing device 40 via the sheet transport path 59. In the fixing device 40, the recording sheet 5 after the secondary transfer is introduced into and passes through the contact portion between the rotating heating rotor 42 and the pressurizing rotor 43. In this manner, necessary fixing processing (heating and pressurization) is performed to fix an unfixed toner image to the recording sheet 5. Finally, the recording sheet 5 after the fixing is completed is discharged to the sheet discharge unit provided on the side surface of the apparatus body (not illustrated), for example.

By the above operation, the recording sheet 5 on which the full-color image configured by combining the toner images of four colors is formed is output.

### Configuration of Charging Device

As illustrated in FIGS. 2 and 3, the charging device 12 according to the first exemplary embodiment is disposed along the axial direction of the photosensitive drum 11, which is an example of a direction intersecting a rotation direction A of the photosensitive drum 11. Here, the axial direction of the photosensitive drum 11 is the longitudinal direction of the charging device 12. In FIG. 3, reference symbol L indicates the longitudinal direction of the charging device 12. Reference symbol W indicates the width direction of the charging device 12. Reference symbol H indicates a height direction of the charging device 12.

Note that, in FIG. 3, a case where the charging device 12 is disposed directly above the photosensitive drum 11 is illustrated. In this case, the height direction H of the charging device 12 matches the vertical direction. However, the charging device 12 is not limited to being disposed directly above the photosensitive drum 11. The charging device 12 may be disposed at an oblique position along the circumferential direction of the photosensitive drum 11. In this case, the height direction H of the charging device 12 is different from the vertical direction.

As illustrated in FIG. 2, the charging device 12 includes, broadly, a shield case 120 as an example of a housing, a single or a plurality of (three in the illustrated example) discharge wires 121a, 121b, and 121c as an example of a discharge electrode, and the grid electrode 122 as an example of the control electrode.

The shield case 120 consists of metal such as stainless steel or aluminum. The shield case 120 functions as a counter electrode in a case where a high voltage is applied to the discharge wires 121a, 121b, and 121c to generate a corona discharge. The shield case 120 is formed in a rectangular parallelepiped shape that has an opening portion 123 where the entire surface of the surface (lower surface in the drawing) facing the photosensitive drum 11 is open and that is elongated along the axial direction of the photosensitive drum 11. The shield case 120 includes a ceiling wall 120a, left and right side walls 120b and 120c, and two partition walls 120d and 120d. The ceiling wall 120a is positioned at an upper end portion on a side opposite to the photosensitive drum 11. The left and right side walls 120b and 120c are provided in a state of being bent downward to face the photosensitive drum 11 from both ends along the width direction W of the ceiling wall 120a. The partition wall 120d partitions a space in the shield case 120 along the width direction W as the rotation direction A of the photosensitive drum 11, according to the number of discharge wires 121a, 121b, and 121c. Note that, in a case where there is one discharge wire 121, the partition wall 120d is not provided. The shield case 120 is applied with the same high voltage as the grid electrode 122 or is grounded. The cylindrical or columnar conductive base of the photosensitive drum 11 is grounded as described above.

A blowing port 120e that blows air into the shield case 120 is opened in the ceiling wall 120a of the shield case 120. The blowing port 120e is opened over the entire length along the longitudinal direction L at the center of the ceiling wall 120a along the width direction W. Air is sent from the blowing port 120e toward the surface of the photosensitive drum 11. As a result, discharge products such as ozone generated by the corona discharge are removed.

The discharge wires 121a, 121b, and 121c consist of tungsten, carbon tungsten, tungsten subjected to gold plating, or the like. For example, a negative polarity of a high voltage of several K to about 8 KV is applied to the discharge wires 121a, 121b, and 121c by a high-voltage power source (not illustrated). For example, the same high voltage is applied to the discharge wires 121a, 121b, and 121c. However, different high voltages may be applied to the discharge wires 121a, 121b, and 121c. For example, the highest high voltage is applied to the discharge wire 121a positioned on the most upstream side along the rotation direction A of the photosensitive drum 11. The same voltage lower than the highest voltage may be applied to the other discharge wires 121b and 121c, or a lower high voltage may be applied to the discharge wires 121b and 121c in this order. The reason why the applied voltage of the discharge wire 121a positioned on the most upstream side along the rotation direction A of the photosensitive drum 11 is set to the highest value is that the charging potential of the photosensitive drum 11 is substantially determined by the discharge wire 121a.

The grid electrode 122 is disposed in the opening portion 123 of the shield case 120 facing the photosensitive drum 11, in a state of being curved in an arc shape along the surface shape of the photosensitive drum 11. For example, a high voltage substantially equal to the desired potential is applied to the grid electrode 122 by a high-voltage power source (not illustrated) in order to obtain the desired charging potential of the photosensitive drum 11. Note that the grid electrode 122 does not necessarily need to be disposed in a state of being curved along the surface shape of the photosensitive drum 11, and may be bent along the surface shape of the photosensitive drum 11 or may be formed in a planar shape.

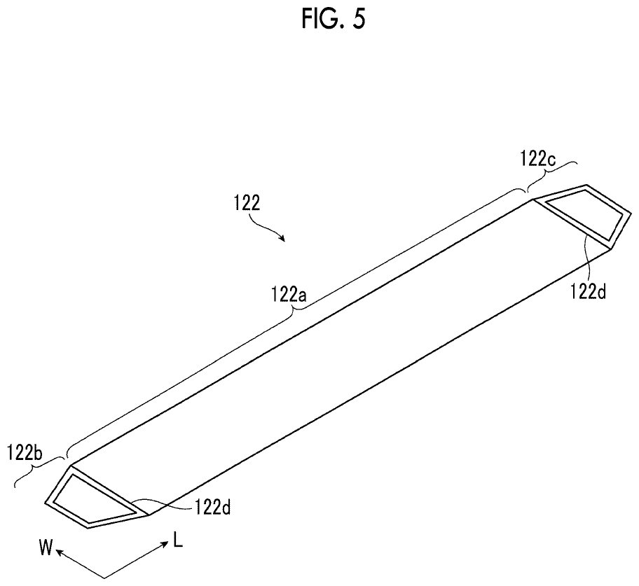

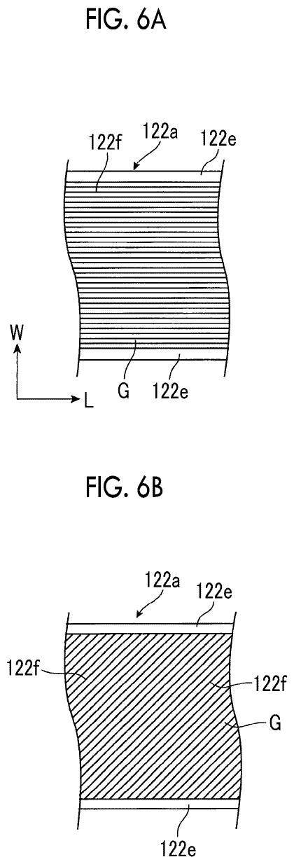

For example, as illustrated in FIG. 5, the grid electrode 122 is formed in a flat plate shape having an elongated rectangular plane corresponding to the opening portion 123 of the shield case 120 by performing an etching treatment, press working, or the like on a thin plate-shaped member consisting of metal such as tungsten, carbon tungsten, or tungsten subjected to gold plating. The grid electrode 122 integrally includes a controller 122a and connection portions 122b and 122c. The controller 122a is provided over the entire region excluding both end portions of the grid electrode 122 along the longitudinal direction L. As illustrated in FIG. 3, the controller 122a of the grid electrode 122 has the same length as an image forming region of the photosensitive drum 11 along the axial direction of the photosensitive drum 11. The connection portions 122b and 122c are respectively provided at both end portions of the controller 122a along the longitudinal direction. A boundary portion 122d formed in a short band shape along the longitudinal direction L is provided between the controller 122a and each of the connection portions 122b and 122c. Note that, as illustrated in FIGS. 6A and 6B, in the grid electrode 122, slightly wider band-shaped edge portions 122e may be provided at both end portions along the width direction W.

As the controller 122a of the grid electrode 122, as illustrated in FIG. 6A, a controller is used in which a plurality of linear conductors 122f, 122f, and the like having a narrow width along the longitudinal direction L are disposed in parallel with each other at a required density along the width direction W. In addition, as the controller 122a of the grid electrode 122, as illustrated in FIG. 6B, a controller is used in which a plurality of linear conductors 122f, 122f, and the like having a narrow width and inclined along a direction intersecting the longitudinal direction L are arranged in parallel with each other at a required density. The controller 122a has fine gaps G formed between the plurality of linear conductors 122f, 122f, and the like uniformly along the width direction W and the longitudinal direction L.

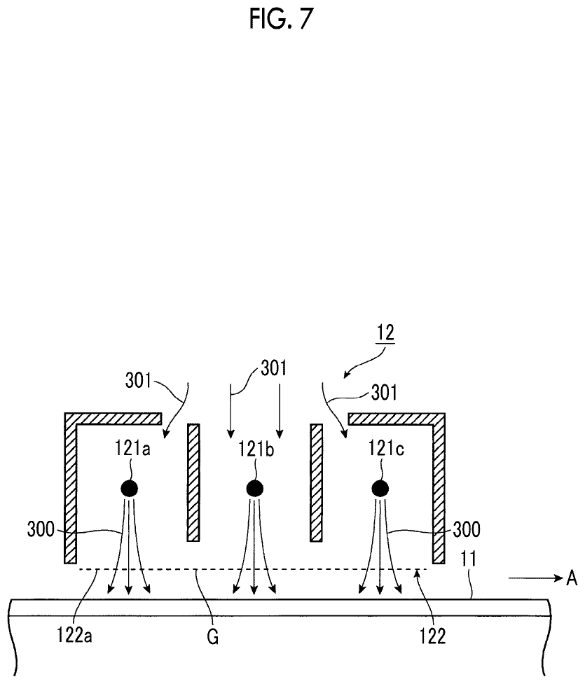

As illustrated in FIG. 7, the controller 122a of the grid electrode 122 charges the photosensitive drum 11 by causing charged particles such as ions generated by corona discharge, which is generated by applying a high voltage to the discharge wires 121a, 121b, and 121c, to adhere to the surface of the photosensitive drum 11 through the gaps G formed between the linear conductors 122f, 122f, and the like having a narrow width. In addition, the controller 122a of the grid electrode 122 controls the charging potential of the photosensitive drum 11 by the action of the electric field formed by the voltage applied to the controller 122a. Note that, in FIG. 7, for convenience, the surface of the photosensitive drum 11 and the grid electrode 122 are illustrated as a plane.

As illustrated in FIG. 5, the connection portions 122b and 122c of the grid electrodes 122 are configured to such that a trapezoidal frame protrudes toward the end portions at both end portions along the longitudinal direction L. The connection portions 122b and 122c are fixed in a state where a tension is applied by being locked to a locking portion provided in the insulating block described later.

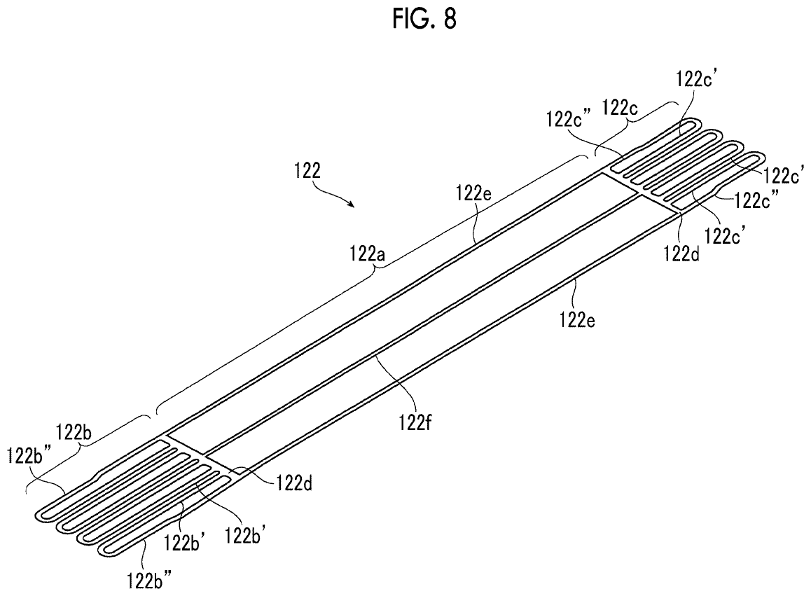

Note that, as the connection portions 122b and 122c of the grid electrode 122, as illustrated in FIG. 8, connection portions may be used in which a plurality of connection pieces 122b′, 122c′, 122b″, and 122c″ formed in a loop shape are disposed along the width direction W.

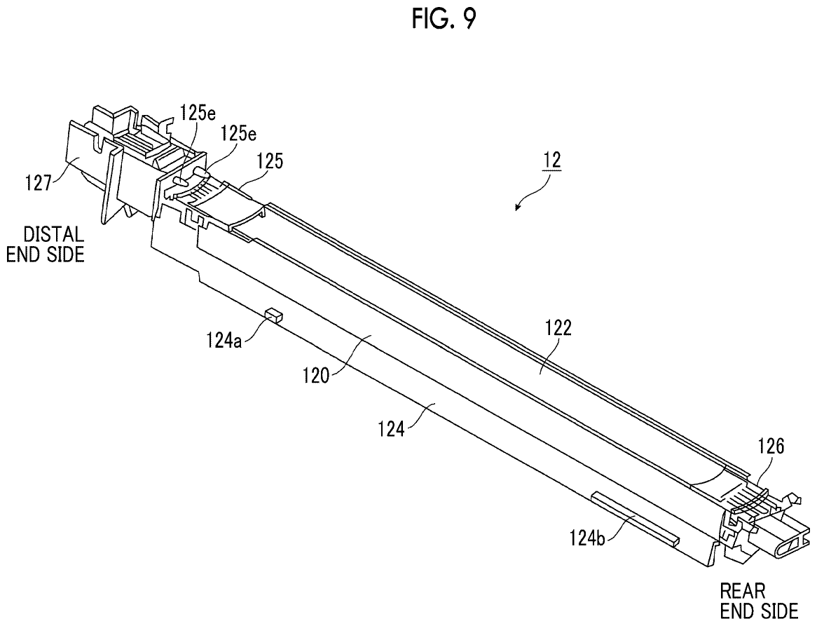

The configuration of the charging device 12 will be further described. As illustrated in FIG. 9, the charging device 12 includes a guide member 124, front-end and rear-end insulating blocks 125 and 126, and a mounting member 127. The guide member 124 is provided on the surface (lower surface in the drawing) of the shield case 120 on a side opposite to the photosensitive drum 11, along the longitudinal direction. The front-end and rear-end insulating blocks 125 and 126 are respectively disposed at both ends of the shield case 120 along the longitudinal direction L. The mounting member 127 is provided at an end portion on the front surface side of the front-end insulating block 125 disposed on the front side of the image forming apparatus 1.

The guide member 124 is formed in an elongated flat plate shape with a synthetic resin or the like. On an outer surface of the guide member 124, two guide convex portions 124a and 124b for guiding the charging device 12 in a case of mounting the charging device 12 on the image forming apparatus 1 are provided at both end portions along the longitudinal direction. The two guide convex portions 124a and 124b are formed such that the guide convex portion 124b disposed on the back surface side of the image forming apparatus 1 is longer than the guide convex portion 124a disposed on the front surface side of the image forming apparatus 1.

The front-end and rear-end insulating blocks 125 and 126 consist of one or a plurality of insulating members made of synthetic resin. The insulating blocks 125 and 126 are respectively fixed to both end portions of the shield case 120 along the longitudinal direction L by means of snap engagement or the like. The three discharge wires 121a, 121b, and 121c and the grid electrode 122 are tensioned on the front-end and rear-end insulating blocks 125 and 126. One end of each of the discharge wires 121a, 121b, and 121c is fixed to one insulating block 126 of the front-end and rear-end insulating blocks 125 and 126, and the other end thereof is fixed to the other insulating block 125 by applying a required tension thereto via an elastic member such as a coil spring.

As illustrated in FIG. 10, the rear-end insulating block 126 is provided with a curved-shaped holding portion 126a, and a plurality of locking claws 126b, 126b, and the like. The holding portion 126a holds the rear end portion of the grid electrode 122 by deforming the rear end portion into a curved shape conforming to the surface shape of the photosensitive drum 11. The plurality of locking claws 126b, 126b, and the like fix the connection portion 122c of the grid electrode 122 in a locked state. In addition, a semi-cylindrical and square tubular conductive portion 126c is provided at the distal end of the rear-end insulating block 126. The conductive portion 126c includes a plurality of current supply electrodes (not illustrated) for applying current to each of the shield case 120, the discharge wires 121a, 121b, and 121c, and the grid electrode 122. The conductive portion 126c of the rear-end insulating block 126 is connected to an electrode on the image forming apparatus 1 side in a case where the charging device 12 is mounted on the image forming apparatus 1. As a result, current can flow through the shield case 120, the discharge wires 121a, 121b, and 121c, and the grid electrode 122.

The rear-end insulating block 126 is provided such that positioning pins 126d and 126d protrude toward the inner side along the longitudinal direction. As illustrated in FIG. 4, the positioning pins 126d and 126d are fitted into the positioning holes 206a and 206b of the positioning portion 206 provided in the support portion 203 of the rear end of the image forming unit 200, thereby performing the positioning of the charging device 12.

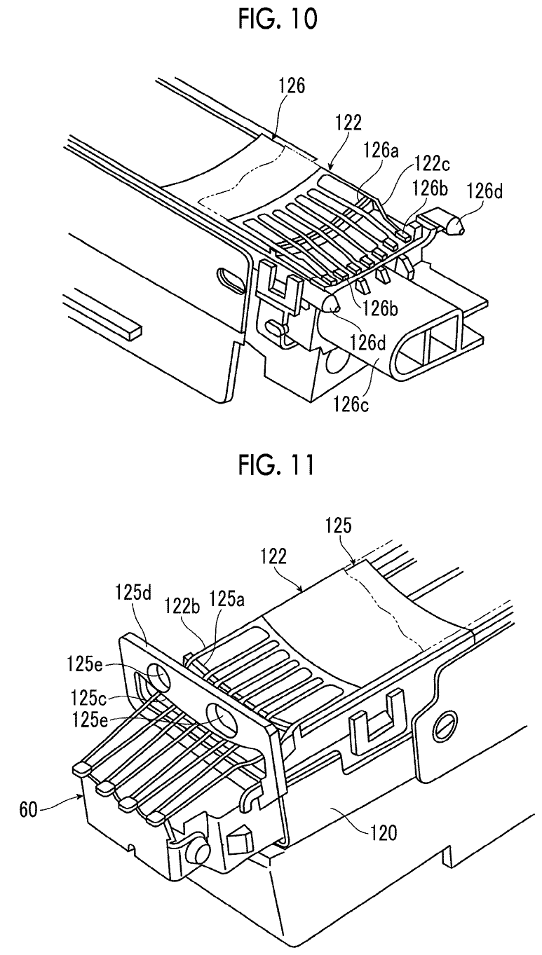

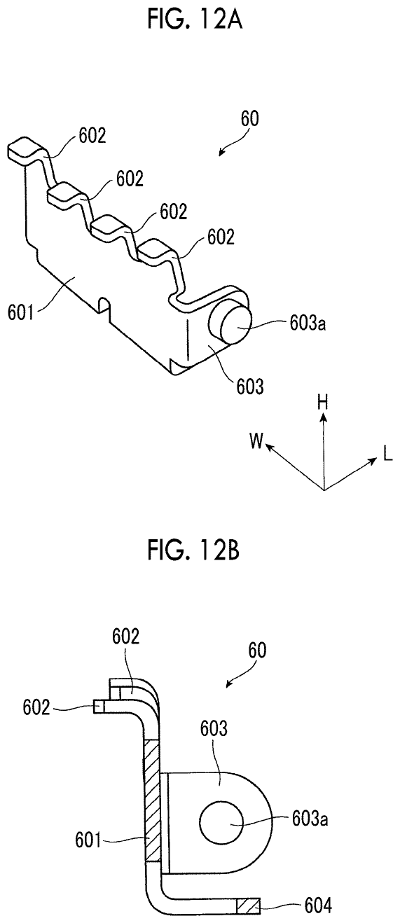

As illustrated in FIG. 11, the front-end insulating block 125 is provided with a curved-shaped holding portion 125a, and a tension member 60. The holding portion 125a holds the front end portion of the grid electrode 122 by deforming the front end portion into a curved shape conforming to the surface shape of the photosensitive drum 11. The tension member 60 applies tension by displacing the connection portion 122b of the grid electrode 122 outward with respect to a charging region of the grid electrode 122 to tension the connection portion 122b. The tension member 60 is attached to the front-end insulating block 125 to be rotatable about the rotation axis disposed along a width direction W of the charging device 12.

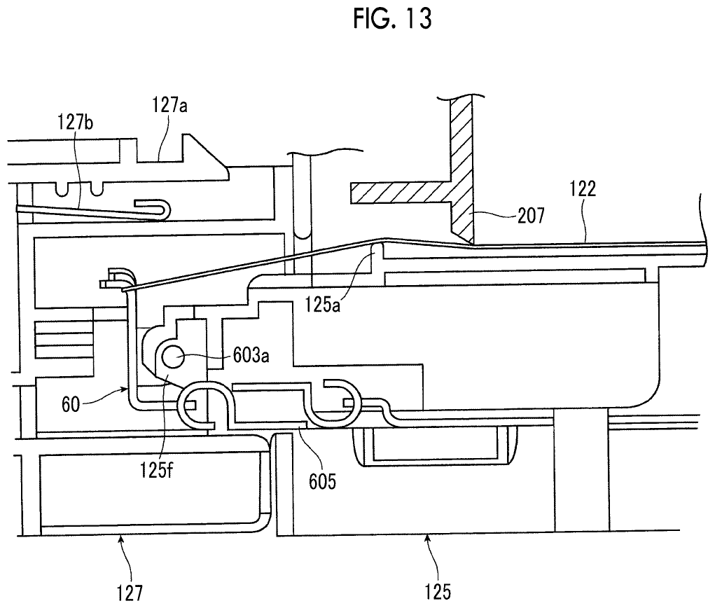

As illustrated in FIG. 13, the holding portions 125a and 126a of the insulating blocks 125 and 126 and the curved portions 207 and 208 of the image forming unit 200 are disposed to slightly protrude to the opposite member side with respect to the tension position of the grid electrode 122. As a result, the shape and position of the grid electrode 122 are defined by the curved portions 207 and 208 of the image forming unit 200.

As illustrated in FIG. 11, a standing wall 125d in which an insertion hole 125c through which the connection portion 122b of the grid electrode 122 is inserted is opened is provided in the front-end insulating block 125. In addition, on the standing wall 125d of the insulating block 125, positioning pins 125e and 125e (refer to FIG. 9) are provided to protrude toward the charging region of the photosensitive drum 11 along a longitudinal direction L. As illustrated in FIG. 9, the positioning pins 125e and 125e perform the positioning of the front end portion of the charging device 12 in a case where the charging device 12 is mounted on the image forming apparatus 1 along the width direction of the upper portion of the insertion hole 125c.

As illustrated in FIGS. 12A and 12B, the tension member 60 provided in the front-end insulating block 125 is formed by performing press working, bending working, or the like on a sheet metal consisting of metal such as stainless steel, or by integral molding of a synthetic resin. The tension member 60 includes a body portion 601, a plurality of locking claw portions 602, 602, and the like, shaft support portions 603 and 603, and a connection portion 604. In the body portion 601, a front surface shape is formed to be a horizontally long rectangular shape along the width direction W of the charging device 12. The plurality of locking claw portions 602, 602, and the like are provided to protrude upward from the upper end of the body portion 601 at a required interval. The shaft support portions 603 and 603 are bent to be orthogonal to the body portion 601 from both end portions along the width direction of the body portion 601. The connection portion 604 is provided at the lower end portion of the body portion 601 to be bent in the same direction as the shaft support portions 603 and 603, and connects one end of a coil spring 605 as an example of a biasing unit.

Regarding the locking claw portions 602, 602, and the like of the tension member 60, the locking claw portions 602 and 602 at both end portions along the width direction W are disposed at positions close to the grid electrode 122. As a result, the distances between the locking claw portions 602, 602, and the like and the respective connection pieces 122b′ and 122b″ of the connection portion 122b of the grid electrode 122 disposed in a curved shape are substantially equal to each other.

The shaft support portions 603 and 603 of the tension member 60 are provided such that the rotation axes 603a and 603a protrude toward both end portions along the width direction. As illustrated in FIG. 13, the rotation axes 603a and 603a of the tension member 60 are rotatably supported by a shaft support portion 125f provided inside the front-end insulating block 125.

As illustrated in FIG. 13, one end of the coil spring 605 is connected to the connection portion 604 of the tension member 60. The other end of the coil spring 605 is fixed inside the insulating block 125. As a result, the tension member 60 is biased along a counterclockwise direction in the drawing. Tension is applied to the grid electrode 122 locked to the locking claw portions 602, 602, and the like of the tension member 60, by the coil spring 605.

The mounting member 127 of the charging device 12 is a member for mounting the charging device 12 in a fixed state in a case where the charging device 12 is mounted on the image forming apparatus 1. As illustrated in FIG. 13, a fixing arm 127a biased along the counterclockwise direction by a spring 127b is rotatably attached to the mounting member 127. The mounted state of the charging device 12 with respect to the image forming apparatus 1 is released by manually gripping a release lever (not illustrated) provided in the mounting member 127 and rotating the fixing arm 127a along a clockwise direction.

Incidentally, the charging device 12 configured as described above generates the corona discharge by applying a high voltage to the discharge wires 121a, 121b, and 121c, as illustrated in FIG. 7. Then, the charging device 12 charges the photosensitive drum 11 by causing charged particles such as ions generated by the corona discharge to pass through the grid electrode 122 and adhere to the surface of the photosensitive drum 11. In addition, the controller 122a of the grid electrode 122 controls the charging potential of the photosensitive drum 11 by the action of the electric field formed by the voltage applied to the controller 122a.

In this case, in the charging device 12, ion wind 300 heading from the discharge wires 121a, 121b, and 121c to the surface of the photosensitive drum 11 positioned directly below is generated. In addition, the charging device 12 is configured to remove the discharge products by blowing air (air blowing 301) from the blowing port 120e of the shield case 120 toward the surface of the photosensitive drum 11. Therefore, the controller 122a of the grid electrode 122 tensioned on the opening portion 123 of the shield case 120 is likely to vibrate due to the influence of the ion wind 300 or the air blowing 301.

In addition, the charging device 12 is configured such that the controller 122a of the grid electrode 122 tensions a plurality of linear conductors 122f, 122f, and the like along the longitudinal direction L. Therefore, the linear conductors 122f, 122f, and the like of the grid electrode 122 are likely to vibrate in resonance with a driving force transmission unit such as a drive motor that rotationally drives the photosensitive drum 11, the developing device 14, or the intermediate transfer belt 21 of the image forming apparatus 1 or a drive gear that transmits a driving force.

The charging device 12 has a technical problem that, in a case where the linear conductors 122f, 122f, and the like of the controller 122a vibrate, the charged particles such as ions passing through the controller 122a are affected by the vibration, and thus unevenness occurs in the charging potential of the surface of the photosensitive drum 11.

The charging device according to the first exemplary embodiment is configured such that the control electrode includes the plurality of linear conductors disposed to intersect the rotation direction of the charged body at any angle, and the plurality of connection portions that connect the linear conductors along the rotation direction of the charged body and are disposed more in a region of a central portion than in a region of both end portions in a direction intersecting the rotation direction of the charged body.

In addition, the charging device according to the first exemplary embodiment is configured such that the control electrode includes the plurality of linear conductors disposed to intersect the rotation direction of the charged body at any angle, and the plurality of connection portions that connect the linear conductors along the rotation direction of the charged body, and are disposed more in the facing region where the discharge electrode and the control electrode face each other, than in the non-facing region where the discharge electrode and the control electrode do not face each other in the rotation direction of the charged body.

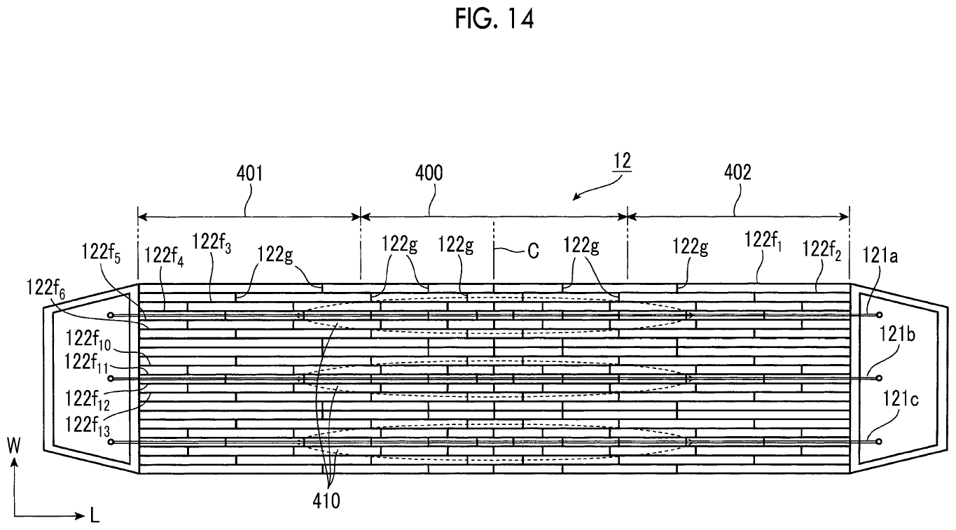

That is, as illustrated in FIG. 14, the charging device 12 according to the first exemplary embodiment uses, as the grid electrode 122, a grid electrode is used in which the linear conductors 122f, 122f, and the like disposed along the longitudinal direction L of the charging device 12 as the axial direction of the photosensitive drum 11 are disposed in parallel with each other with the fine gaps G along the width direction W of the charging device 12 as the rotation direction of the photosensitive drum 11.

In addition, the grid electrode 122 of the charging device 12 includes a plurality of connection portions 122g, 122g, and the like that connect the linear conductors 122f, 122f, and the like to each other along the width direction W of the charging device 12 as the rotation direction of the photosensitive drum 11. The plurality of connection portions 122g, 122g, and the like may connect the linear conductors 122f, 122f, and the like to each other along the width direction W of the charging device 12. That is, the plurality of connection portions 122g, 122g, and the like are not limited to being disposed along the width direction W of the charging device 12, and may be disposed to be inclined with respect to the width direction W of the charging device 12.

For example, in a case where the grid electrode 122 is divided into three equal portions of a central portion 400 and both end portions 401 and 402 along the longitudinal direction L of the charging device 12, the plurality of connection portions 122g, 122g, and the like are configured to be disposed more in a region of the central portion than in a region of both end portions of the grid electrode 122. Note that, in FIG. 14, for convenience of description, the central portion 400 is illustrated to be slightly wider than the both end portions 401 and 402.

Furthermore, among the plurality of connection portions 122g, 122g, and the like, an uppermost linear conductor 122f₁ along the width direction W of the charging device 12 and a second linear conductor 122f₂ adjacent to the linear conductor 122f₁ are focused on. Then, the plurality of connection portions 122g, 122g, and the like are provided such that only one connection portion is provided in each region of the both end portions 401 and 402 of the grid electrode 122 and three connection portions are provided in the central portion 400.

Similarly, the second linear conductor 122f₂ adjacent to the uppermost linear conductor 122f₁ along the width direction of the charging device 12 and a third linear conductor 122f₃ adjacent to the second linear conductor 122f₂ are focused on. Then, the plurality of connection portions 122g, 122g, and the like are provided such that only one connection portion is provided in each region of the both end portions 401 and 402 of the grid electrode 122 and four connection portions are provided in the central portion 400.

The same applies to the other linear conductors 122f, and the plurality of connection portions 122g, 122g, and the like are provided more in the region of the central portion 400 than in the regions of both end portions 401 and 402 of the grid electrode 122.

In other words, the plurality of connection portions 122g, 122g, and the like are disposed such that the density is higher in the region of the central portion 400 than the density in the regions of the both end portions 401 and 402 of the grid electrode 122. Here, the density of the plurality of connection portions 122g, 122g, and the like is the number of connection portions 122g, 122g, and the like disposed per unit length along the longitudinal direction L of the linear conductor 122f.

In addition, in the charging device 12 according to the first exemplary embodiment, as illustrated in FIG. 14, the connection portions 122g, 122g, and the like of the grid electrode 122 are disposed more in a facing region 410 where the discharge wires 121a, 121b, and 121c and the grid electrode 122 face each other than in a non-facing region 411 where the discharge wires 121a, 121b, and 121c and the grid electrode 122 do not face each other.

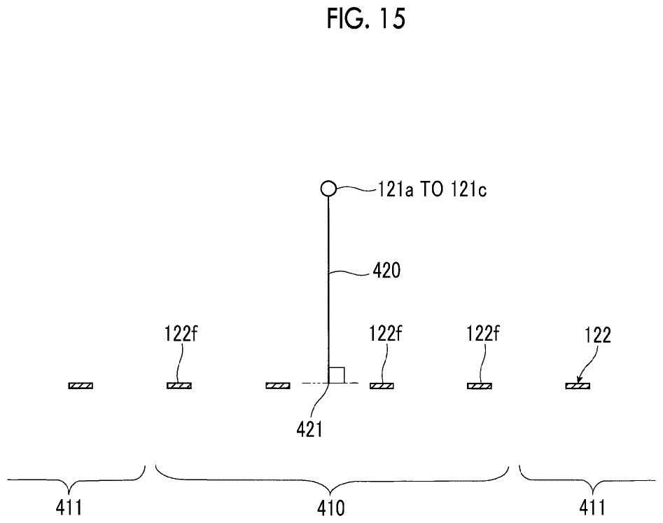

Here, the facing region 410 where the discharge wires 121a, 121b, and 121c and the grid electrode 122 face each other is not only a region at a position directly below the discharge wires 121a, 121b, and 121c but also a region that is directly affected by the ion wind 300 generated in a case where a high voltage is applied to the discharge wires 121a, 121b, and 121c as illustrated in FIG. 7. The region that is directly affected by the ion wind is also changed depending on the applied voltage of the discharge wires 121a, 121b, and 121c, the distance between the discharge wires 121a, 121b, and 121c and the grid electrode 122, and the like. Here, the facing region 410 is a region where, in a case where a perpendicular line 420 is drawn from the discharge wires 121a, 121b, and 121c to the surface of the grid electrode 122, n linear conductors 122f are present on both sides of a position 421 at which the perpendicular line 420 intersects the surface of the grid electrode 122, as illustrated in FIG. 15. The value of n depends on the arrangement density of the linear conductors 122f, 122f, and the like, but is, for example, a value of 10 or less, and is preferably a value of 5 or less. Note that a case where the grid electrode 122 is curved is a case where a perpendicular line passing through the discharge wires 121a, 121b, and 121c is drawn with respect to a tangent line to the surface of the grid electrode 122.

In the illustrated exemplary embodiment, in a case where the perpendicular line 420 is drawn from the discharge wires 121a, 121b, and 121c to the surface of the grid electrode 122, a region where two linear conductors 122f are present on both sides of the position at which the perpendicular line 420 intersects the surface of the grid electrode 122 is the facing region 410, as illustrated in FIG. 15.

Furthermore, in the illustrated exemplary embodiment, as indicated by a broken line in FIG. 14, the linear conductor 122f, which is positioned in the facing region 410, of the uppermost discharge wire 121a is a region where a total of four linear conductors 122f, which are the third to sixth linear conductors from the uppermost linear conductor 122f, are present.

Similarly, in the illustrated exemplary embodiment, as illustrated in FIG. 14, the linear conductor 122f, which is positioned in the facing region, of the discharge wire 121b positioned in the central portion is a region where a total of four linear conductors 122f from the tenth to thirteenth linear conductors from the uppermost linear conductor 122f are present.

Furthermore, in the illustrated exemplary embodiment, as illustrated in FIG. 14, the linear conductor 122f, which is positioned in the facing region, of the lowermost discharge wire 121c is a region where a total of four linear conductors 122f from the third to sixth linear conductors from the lowermost linear conductor 122f are present.

In a case where the linear conductors 122f positioned in the facing region are focused on, for example, the number of the plurality of connection portions 122g, 122g, and the like that connect the third and fourth linear conductors 122f from the uppermost linear conductor 122f is nine. In addition, the number of the plurality of connection portions 122g, 122g, and the like that connect the fourth and fifth linear conductors 122f from the uppermost linear conductor 122f is ten. Furthermore, the number of the plurality of connection portions 122g, 122g, and the like that connect the fifth and sixth linear conductors 122f from the uppermost linear conductor 122f is nine.

On the other hand, in a case where the linear conductors 122f positioned in the non-facing region other then the facing region are focused on, for example, the number of the plurality of connection portions 122g, 122g, and the like that connect the first and second linear conductors 122f from the uppermost linear conductor 122f is five, and the number of the plurality of connection portions 122g, 122g, and the like that connect the second and third linear conductors 122f from the uppermost linear conductor 122f is six.

In this manner, in the charging device 12 according to the first exemplary embodiment, as illustrated in FIG. 14, the number connection portions 122g, 122g, and the like of the grid electrode 122 disposed in the non-facing region where the discharge electrode and the control electrode do not face each other is five or six, whereas the number of connection portions 122g, 122g, and the like disposed in the facing region where the discharge electrode and the control electrode face each other is nine or ten, which is approximately twice as many.

The same applies to the facing region facing the other discharge wires 121b and 121c.

Furthermore, in the charging device 12 according to the exemplary embodiment, the fourth and fifth linear conductors 122f from the uppermost linear conductor 122f positioned in the facing region facing the discharge wire are focused on. Then, regarding the plurality of connection portions 122g, 122g, and the like that connect the linear conductors 122f to each other, there are provided two connection portions in the regions of the both end portions 401 and 402 of the grid electrode 122, but there are provided six connection portions in the region of the central portion 400.

### Action of Charging Device

In the charging device according to the first exemplary embodiment, the occurrence of the charging unevenness due to the vibration of the control electrode may be suppressed as compared with a case where the plurality of connection portions constituting the control electrode are disposed without considering the vibration characteristics of the control electrode.

In the image forming apparatus 1, as illustrated in FIG. 1, during the image formation in respective image creating devices 10 of yellow (Y), magenta (M), cyan (C), and black (K), the surface of each photosensitive drums 11 is uniformly charged to a required potential by the charging device 12.

In this case, in the charging device 12, as illustrated in FIG. 2, a high voltage is applied to the discharge wires 121a, 121b, and 121c, and a required high voltage is applied to the grid electrode 122.

In the charging device 12, as illustrated in FIG. 7, the linear conductors 122f, 122f, and the like constituting the grid electrode 122 are in a state where vibration is likely to occur. The reason for this is that, as described above, the influence of the ion wind 300 generated by applying a high voltage to the discharge wires 121a, 121b, and 121c, the influence of the air blowing 301 sent from the blowing port 120e of the shield case 120, and the vibration of the drive motor and the driving force transmission unit that drive the photosensitive drum 11 or the developing device 14 disposed around the charging device 12, the intermediate transfer device 20, and the like are transmitted via a frame or the like.

Meanwhile, as illustrated in FIG. 14, the charging device 12 according to the first exemplary embodiment includes the plurality of connection portions 122g, 122g, and the like that connect the linear conductors 122f, 122f, and the like adjacent to each other along the width direction W of the charging device 12 as the rotation direction of the photosensitive drum 11, regarding the linear conductors 122f, 122f, and the like constituting the grid electrode 122.

In addition, the plurality of connection portions 122g, 122g, and the like are disposed more in the region of the central portion 400 than in the regions of the both end portions 401 and 402 of the grid electrode 122. In other words, the plurality of connection portions 122g, 122g, and the like are disposed at a higher density in the region of the central portion 400 where the vibration is likely to occur, than in the regions of the both end portions 401 and 402 of the grid electrode 122.

Furthermore, the plurality of connection portions 122g, 122g, and the like are disposed more in the facing region 410 where the discharge wires 121a, 121b, and 121c and the grid electrode 122 face each other and the vibration IS likely to occur due to the ion wind 300 from the discharge wires 121a, 121b, and 121c, than in the non-facing region 411 where the discharge wires 121a, 121b, and 121c and the grid electrode 122 do not face each other. In other words, the plurality of connection portions 122g, 122g, and the like are disposed at a higher density in the facing region 410 where the discharge wires 121a, 121b, and 121c and the grid electrode 122 face each other, than in the non-facing region 411 where the discharge wires 121a, 121b, and 121c and the grid electrode 122 do not face each other.

Therefore, in the charging device 12 according to the first exemplary embodiment, the adjacent linear conductors 122f, 122f, and the like of the grid electrode 122 are connected to each other by a large number of connection portions 122g, 122g, and the like in the region where the vibration is likely to occur, and the occurrence of the vibration in the linear conductors 122f, 122f, and the like may be prevented or suppressed. In addition, the occurrence of the charging unevenness due to the vibration of the linear conductors 122f, 122f, and the like of the grid electrode 122 may be prevented or suppressed.

### Second Exemplary Embodiment

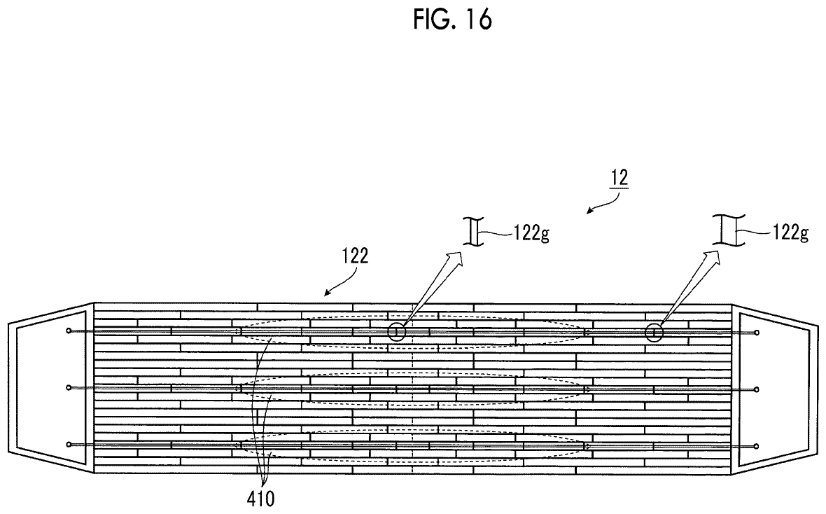

FIG. 16 is a configuration diagram illustrating a charging device according to a second exemplary embodiment of the present invention. The charging device according to the second exemplary embodiment is configured such that the control electrode has a uniform opening ratio along the direction intersecting the rotation direction of the charged body.

That is, as illustrated in FIG. 16, the charging device 12 according to the second exemplary embodiment is configured such that a line width of the connection portions 122g, 122g, and the like is different in accordance with an arrangement density of the plurality of connection portions 122g, 122g, and the like.

As illustrated in FIG. 7, the controller 122a of the grid electrode 122 charges the photosensitive drum 11 by causing charged particles such as ions generated by corona discharge, which is generated by applying a high voltage to the discharge wires 121a, 121b, and 121c, to adhere to the surface of the photosensitive drum 11 through the gaps G formed between the linear conductors 122f, 122f, and the like having a narrow width. In addition, the controller 122a of the grid electrode 122 controls the charging potential of the photosensitive drum 11 by the action of the electric field formed by the voltage applied to the controller 122a.

Therefore, in a case where the arrangement density of the plurality of connection portions 122g, 122g, and the like that connect the linear conductors 122f, 122f, and the like constituting the grid electrode 122 is different along the longitudinal direction L of the charging device 12 as the direction intersecting the rotation direction of the photosensitive drum 11, the opening ratio of the grid electrode 122 is not uniform along the longitudinal direction L of the charging device 12.

Here, the opening ratio (%) of the grid electrode 122 is (the area of the gap G per unit area/the unit area)*100.

In a case where the plurality of connection portions 122g, 122g, and the like are disposed at a high density so that the opening ratio of the grid electrode 122 is small, among the charged particles such as ions generated in the discharge wires 121a, 121b, and 121c, the number of charged particles passing through the gaps G and heading toward the surface of the photosensitive drum 11 is reduced, and the proportion of charged particles flowing into the grid electrode 122 is increased.

On the other hand, in a case where the opening ratio of the grid electrode 122 is excessively large, the potential compensation capability of the photosensitive drum 11 by the grid electrode 122 is reduced, and a state close to the corotron is obtained, which is not desirable. Therefore, it is desirable that the opening ratio of the grid electrode 122 is uniform and is, for example, 86% to 95%.

As illustrated in FIG. 16, the charging device 12 according to the second exemplary embodiment is configured such that, in accordance with the arrangement density of the plurality of connection portions 122g, 122g, and the like, the opening ratio of the grid electrode 122 along the longitudinal direction L is uniform by narrowing the line width of the connection portions 122g, 122g, and the like in the region with the high arrangement density and increasing the line width of the connection portions 122g, 122g, and the like in the region with the low arrangement density.

Note that the opening ratio of the grid electrode 122 does not need to be strictly constant along the longitudinal direction L, and, for example, it is desirable that the opening ratio of the grid electrode 122 is uniform in a range of 86% to 95%.

In the charging device 12 according to the second exemplary embodiment, since the opening ratio of the grid electrode 122 is configured to be uniform along the longitudinal direction L, the opening ratio of the grid electrode 122 can be changed by providing the plurality of connection portions 122g, 122g, and the like on the grid electrode 122, and thus fluctuations in charging performance along the longitudinal direction L may be suppressed.

Since other configurations and actions are similar to the configurations and actions in the first exemplary embodiment, the description thereof will be omitted.

### Third Exemplary Embodiment

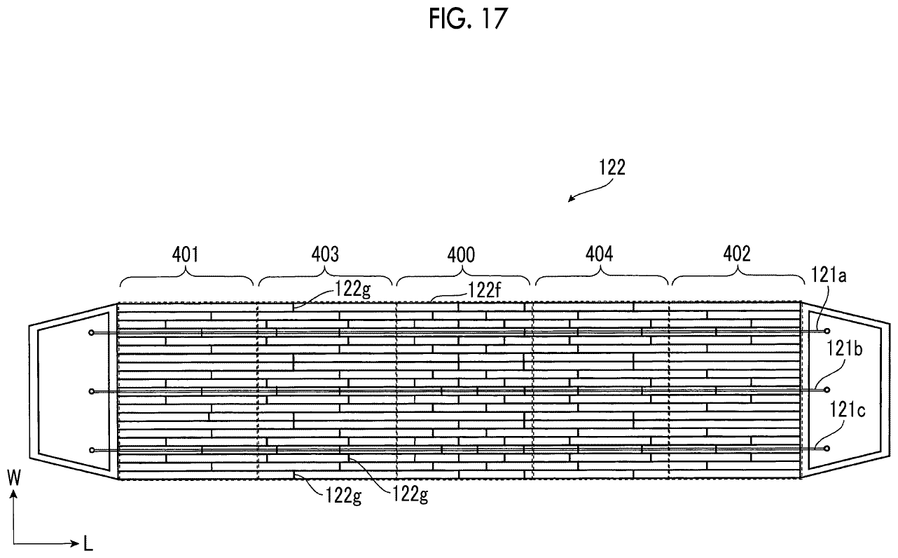

FIG. 17 is a configuration diagram illustrating a charging device according to a third exemplary embodiment of the present invention. The charging device according to the third exemplary embodiment is configured such that the number of divisions in which the control electrode is divided along the direction intersecting the rotation direction of the charged body is increased, and the line widths of the plurality of connection portions in each division region are different from each other.

That is, as illustrated in FIG. 17, the charging device 12 according to the third exemplary embodiment is configured such that the grid electrode 122 is divided into five equal portions along the longitudinal direction to obtain five regions.

The grid electrode 122 has the central portion 400 positioned at the center along the longitudinal direction, regions of both end portions 401 and 402 positioned at both end portions along the longitudinal direction, and regions of intermediate portions 403 and 404 positioned between the central portion and both end portions.

Note that, here, for convenience of description, a case where the grid electrode 122 is divided into five equal portions along the longitudinal direction will be described, but in an actual charging device, for example, it is desirable to divide the grid electrode 122 into about 30 equal portions along the longitudinal direction in order to make the opening ratio uniform.

As illustrated in FIG. 17, in the charging device 12 according to the third exemplary embodiment, for example, the plurality of connection portions 122g, 122g, and the like are disposed on the grid electrode 122 such that 50 connection portions are disposed in the region of the central portion 400 with a line width of 0.8 mm, 30 connection portions are disposed in the regions of the intermediate portions 403 and 404 with a line width of 1.3 mm, and 15 connection portions disposed in the regions of the both end portions 401 and 402 with a line width of 2.7 mm. As a result, since the length of the connection portions 122g, 122g, and the like is constant, the area (opening ratio) occupied by the connection portions 122g, 122g, and the like by providing the plurality of connection portions 122g, 122g, and the like on the grid electrode 122 can be maintained approximately constant, at 50×0.8=40, 30×1.3=39, and 15×2.7=40.5, according to simple calculations.

Since the vibration suppression effect of the grid electrode 122 is more affected by the arrangement density than by the line width of the plurality of connection portions 122g, 122g, and the like, even in a case where the line width of the plurality of connection portions 122g, 122g, and the like is changed, the influence on the vibration suppression effect is small, which can be ignored.

Since other configurations and actions are similar to the configurations and actions in the first exemplary embodiment, the description thereof will be omitted.

### Fourth Exemplary Embodiment

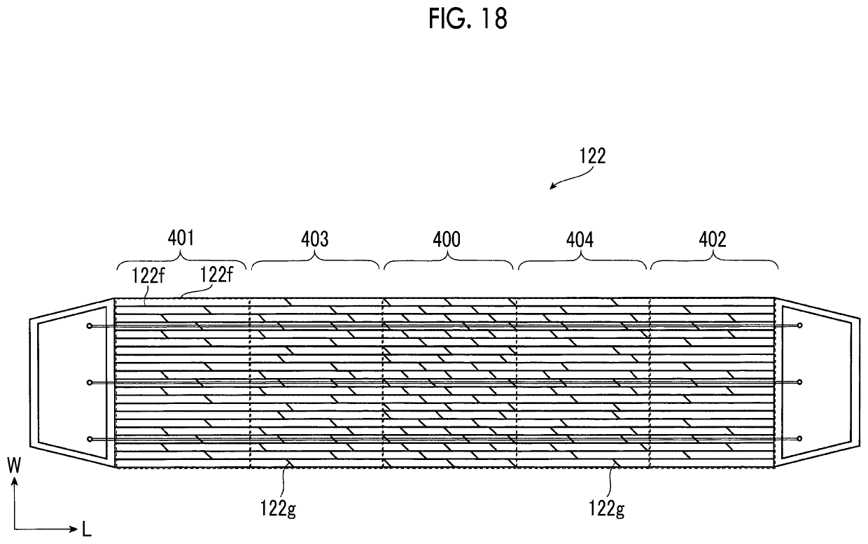

FIG. 18 is a configuration diagram illustrating a charging device according to a fourth exemplary embodiment of the present invention. The charging device according to the fourth exemplary embodiment is configured such that the plurality of connection portions of the control electrode are not disposed along the rotation direction of the charged body but are disposed to be inclined with respect to the rotation direction of the charged body.

That is, as illustrated in FIG. 18, the charging device 12 according to the fourth exemplary embodiment is configured such that the plurality of connection portions 122g, 122g, and the like that connect the linear conductors 122f, 122f, and the like constituting the grid electrode 122 are disposed to be inclined with respect to the width direction W of the charging device 12 as the rotation direction of the photosensitive drum 11.

Furthermore, as illustrated in FIG. 18, in the charging device 12 according to the fourth exemplary embodiment, the start points and the end points of the plurality of connection portions 122g, 122g, and the like are disposed not to overlap with each other.

In a case where the plurality of connection portions 122g, 122g, and the like that connect the linear conductors 122f, 122f, and the like constituting the grid electrode 122 are disposed such that the start points and the end points thereof overlap with each other, there is a concern that positions where the start points and the end points overlap with each other may become a “node” of the vibration and new vibration may occur.

Therefore, in the charging device 12 according to the fourth exemplary embodiment, by disposing the plurality of connection portions 122g, 122g, and the like such that the start points and the end points thereof do not overlap with each other, it is possible to prevent or suppress occurrence of new vibration due to the plurality of connection portions 122g, 122g, and the like becoming “nodes” of the vibration.

Since other configurations and actions are similar to the configurations and actions in the first exemplary embodiment, the description thereof will be omitted.

### Supplementary Note

(((1)))

A charging device comprising:
a discharge electrode; and
a control electrode that is disposed between the discharge electrode and a charged body that is charged by the discharge electrode,
wherein the control electrode includes
   a plurality of linear conductors disposed to intersect a rotation direction of the charged body at any angle, and
   a plurality of connection portions that are members of connecting the linear conductors along the rotation direction of the charged body, and are disposed more in a region of a central portion than in a region of both end portions in a direction intersecting the rotation direction of the charged body.

(((2)))

A charging device comprising:
a discharge electrode; and
a control electrode that is disposed between the discharge electrode and a charged body that is charged by the discharge electrode,
wherein the control electrode includes
   a plurality of linear conductors disposed to intersect a rotation direction of the charged body at any angle, and
   a plurality of connection portions that are members of connecting the linear conductors along the rotation direction of the charged body, and are disposed more in a facing region where the discharge electrode and the control electrode face each other, than in a non-facing region where the discharge electrode and the control electrode do not face each other in the rotation direction of the charged body.

(((3)))

The charging device according to (((1))),
wherein the plurality of connection portions connect the linear conductors that are adjacent to each other among the plurality of linear conductors.

(((4)))

The charging device according to (((3))),
wherein the plurality of connection portions are disposed such that a density of the connection portions is highest in the region of the central portion of the control electrode in the direction intersecting the rotation direction of the charged body, and a density of the connection portions is decreased stepwise toward both end portions of the control electrode.

(((5)))

The charging device according to (((1))),
wherein the plurality of connection portions are disposed including a non-facing region where the discharge electrode and the control electrode do not face each other.

(((6)))

The charging device according to (((5))),
wherein the plurality of connection portions are disposed such that a density of the connection portions in a facing region where the discharge electrode and the control electrode face each other is higher than a density of the connection portions in the non-facing region where the discharge electrode and the control electrode do not face each other in the direction intersecting the rotation direction of the charged body.

(((7)))

The charging device according to (((1))),
wherein an opening ratio of the control electrode along the direction intersecting the rotation direction of the charged body is uniform.

(((8)))

The charging device according to (((7))),
wherein in the plurality of connection portions, a line width of the connection portions in a central portion is narrower than a line width of the connection portions in a region of the both end portions of the control electrode in the direction intersecting the rotation direction of the charged body.

(((9)))

The charging device according to (((1))),
wherein a plurality of discharge electrodes are disposed along the rotation direction of the charged body.

(((10)))

The charging device according to (((9))),
wherein an applied voltage of the discharge electrode on a most upstream side along the rotation direction of the charged body is higher than other applied voltages of the discharge electrodes.

(((11)))

An image forming unit that is attached to and detached from an image forming apparatus, the image forming unit comprising:
the charging device according to any one of (((1))) to (((10))).

(((12)))

An image forming apparatus comprising:
an image holding unit;
a charging unit that charges a surface of the image holding unit; and
an electrostatic latent image forming unit that forms an electrostatic latent image on the surface of the image holding unit charged by the charging unit,
wherein the charging device according to any one of (((1))) to (((10))) is used as the charging unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A charging device comprising:
a discharge electrode; and
a control electrode that is disposed between the discharge electrode and a charged body that is charged by the discharge electrode,
wherein the control electrode includes
a plurality of linear conductors disposed to intersect a rotation direction of the charged body at any angle, and
a plurality of connection portions that are members of connecting the linear conductors along the rotation direction of the charged body, and are disposed more in a region of a central portion than in a region of both end portions in a direction intersecting the rotation direction of the charged body.

2. A charging device comprising:
a discharge electrode; and
a control electrode that is disposed between the discharge electrode and a charged body that is charged by the discharge electrode,
wherein the control electrode includes
a plurality of linear conductors disposed to intersect a rotation direction of the charged body at any angle, and
a plurality of connection portions that are members of connecting the linear conductors along the rotation direction of the charged body, and are disposed more in a facing region where the discharge electrode and the control electrode face each other, than in a non-facing region where the discharge electrode and the control electrode do not face each other in the rotation direction of the charged body.

3. The charging device according to claim 1,
wherein the plurality of connection portions connect the linear conductors that are adjacent to each other among the plurality of linear conductors.

4. The charging device according to claim 3,
wherein the plurality of connection portions are disposed such that a density of the connection portions is highest in the region of the central portion of the control electrode in the direction intersecting the rotation direction of the charged body, and a density of the connection portions is decreased stepwise toward both end portions of the control electrode.

5. The charging device according to claim 1,
wherein the plurality of connection portions are disposed including a non-facing region where the discharge electrode and the control electrode do not face each other.

6. The charging device according to claim 5,
wherein the plurality of connection portions are disposed such that a density of the connection portions in a facing region where the discharge electrode and the control electrode face each other is higher than a density of the connection portions in the non-facing region where the discharge electrode and the control electrode do not face each other in the direction intersecting the rotation direction of the charged body.

7. The charging device according to claim 1,
wherein an opening ratio of the control electrode along the direction intersecting the rotation direction of the charged body is uniform.

8. The charging device according to claim 7,
wherein in the plurality of connection portions, a line width of the connection portion in a central portion is narrower than a line width of the connection portion in a region of both end portions of the control electrode in the direction intersecting the rotation direction of the charged body.

9. The charging device according to claim 1,
wherein a plurality of discharge electrodes are disposed along the rotation direction of the charged body.

10. The charging device according to claim 9,
wherein an applied voltage of the discharge electrode on a most upstream side along the rotation direction of the charged body is higher than other applied voltages of the discharge electrodes.

11. An image forming unit that is attached to and detached from an image forming apparatus, the image forming unit comprising:
the charging device according to claim 1.

12. An image forming unit that is attached to and detached from an image forming apparatus, the image forming unit comprising:
the charging device according to claim 2.

13. An image forming unit that is attached to and detached from an image forming apparatus, the image forming unit comprising:
the charging device according to claim 3.

14. An image forming unit that is attached to and detached from an image forming apparatus, the image forming unit comprising:
the charging device according to claim 4.

15. An image forming unit that is attached to and detached from an image forming apparatus, the image forming unit comprising:
the charging device according to claim 5.

16. An image forming unit that is attached to and detached from an image forming apparatus, the image forming unit comprising:
the charging device according to claim 6.

17. An image forming unit that is attached to and detached from an image forming apparatus, the image forming unit comprising:
the charging device according to claim 7.

18. An image forming unit that is attached to and detached from an image forming apparatus, the image forming unit comprising:
the charging device according to claim 8.

19. An image forming unit that is attached to and detached from an image forming apparatus, the image forming unit comprising:
the charging device according to claim 9.

20. An image forming apparatus comprising:
an image holding unit;
a charging unit that charges a surface of the image holding unit; and
an electrostatic latent image forming unit that forms an electrostatic latent image on the surface of the image holding unit charged by the charging unit,
wherein the charging device according to claim 1 is used as the charging unit.
